(19) United States
(12) Patent Application Publication
(10) Pub. No.: US 2026/0166473 A1
(43) Pub. Date: Jun. 18, 2026

(54) GAS SEPARATION METHOD AND SYSTEM

(71) Applicant: Hans Gude Gudesen, Gamle Fredrikstad (NO)

(72) Inventors: Hans Gude Gudesen, Luzern (CH); Per-Erik Nordal, Asker (NO)

(73) Assignee: Hans Gude Gudesen, Gamle Fredrikstad (NO)

(21) Appl. No.: 18/864,899

(22) PCT Filed: Apr. 25, 2023
(86) PCT No.: PCT/NO2023/050094

§ 371 Date: Nov. 12, 2024

(30) Foreign Application Priority Data
May 12, 2022 (NO) 20220562

(51) Int. Cl. B01D 53/14; B01D 53/18

(52) U.S. Cl. CPC B01D 53/1475; B01D 53/1425; B01D 53/185; B01D 2252/103; B01D 2257/504; B01D 2258/0283

(57) ABSTRACT

A method for separating a gas from a gas mixture (1) is disclosed. The method comprises generating steam (5) under pressure contributing to injecting the gas mixture (1) into a volume of liquid (19). A corresponding system is also disclosed.

### FIELD OF THE INVENTION

The present invention relates to methods for reducing the electrical energy requirements associated with gas/liquid solubility-based processes for selectively separating CO₂ gas from a mixture of gases, and systems for carrying out the methods. It also includes methods and systems for recovering the CO₂ that has been separated from the other gases.

### BACKGROUND OF THE INVENTION

Emissions of CO₂ into the atmosphere from human activities are generally acknowledged as a major unsolved problem both locally where concentrations of CO₂ may become high and cause acute damage to flora and fauna, and on a global scale where the background concentration of CO₂ in the air is steadily rising, causing global warming and destruction of marine habitats. To meet this challenge, great efforts have been spent worldwide to capture and dispose of CO₂, in particular from high volume point emitters such as fossil fueled power plants, cement factories and garbage incinerators. However, the technical solutions that have emerged so far are far from satisfactory. A prominent example is the amine process where CO₂ is separated from flue gases (see, e.g.: https://ccsnorway.com/capture-studies/) which is very energy consuming and expensive, and employs toxic chemicals.

Alternative schemes have been devised to extract CO₂ from a mixture of gases by exploiting differences in their solubilities in water. While attractive in many respects, such schemes include gas/liquid injection and circulation processes that generally involve expenditure of electrical power in some form. In many cases the associated energy costs become prohibitive for successful implementation in industrial settings.

There is thus a pressing need to develop clean, low cost, high capacity solutions that are capable of extracting CO₂ from relevant gas mixtures without incurring large consumption of electrical energy and delivering the CO₂ in a form that facilitates long term sequestration or makes it suited as a feedstock in industrial processes.

### OBJECTS OF THE PRESENT INVENTION

A general object of the present invention is to solve problems of technical solutions according to state of the art as described above.

An object is to contribute to improving solutions for capturing and disposing of CO₂.

A more specific object is to provide solutions for clean, low cost, high capacity extracting of CO₂ from relevant gas mixtures without incurring large consumption of electrical energy.

### SUMMARY OF THE INVENTION

A first aspect of the invention is a method for separating CO2 gas from a gas mixture of CO2 and other gases, using a first and a second reservoir volume separated by a pressure transfer element. The method comprises the following steps:
admitting the gas mixture into the first reservoir volume, and releasing gas from the second volume in a coordinated way;
suspending the admitting and the releasing;
generating steam under pressure, and admitting it into the second reservoir volume;
transmitting pressure in the second reservoir volume to the first reservoir volume via the pressure transfer element, contributing to injecting gas mixture from the first reservoir volume into a volume of liquid, and forming bubbles therein; and
dissolving in the volume of liquid a relatively larger proportion of CO2 gas than of the other gases in the bubbles, transporting gas remaining in the bubbles out of the volume liquid by allowing the bubbles floating to surface of the volume of liquid, thus separating CO2 gas from the gas mixture and giving CO2 enriched liquid.

Optionally, the generating of steam under pressure comprises exploiting thermal energy from a thermal source, where optionally, the thermal source comprises the gas mixture, and where further optionally, the generating of steam comprises heating liquid in a heat exchanger by the gas mixture.

Optionally, the method comprises passing the CO2 enriched liquid through a turbine eliciting flashing of dissolved CO2 into gas phase, generating energy, and producing degassed liquid, and further optionally, the method comprises collecting/removing the CO2 in gas phase.

Optionally, the method comprises gathering the degassed liquid in a reservoir and admitting the steam under pressure into the reservoir lifting the degassed liquid to a higher altitude, and optionally, it comprises returning the degassed liquid into the volume of liquid in a closed cycle operation. Optionally, the method comprises supplementing the degassed liquid with a smaller portion of liquid to compensate for evaporation losses.

Optionally, the liquid is water, the volume of liquid is a water volume, the CO2 enriched liquid is CO2 enriched water, and the degassed liquid is degassed water. Optionally, the gas mixture is a flue gas.

Another aspect of the invention is a system for separating CO2 gas from a gas mixture of CO2 and other gases, where the system comprises:
a first and a second reservoir volume separated by a pressure transfer element arranged to transfer pressure between the first and second reservoir volume;
a volume of liquid with a surface, where the volume of liquid is fluidly connected to the first reservoir volume, and where the liquid has a higher solubility of CO2 than of the other gases;
means for (controllably) injecting the gas mixture into the first reservoir volume, and means for in a coordinated way releasing gas from the second reservoir volume; and
means for generating steam under pressure, and admitting it into the second reservoir volume, thereby via the pressure transfer element contributing to injecting gas mixture from the first reservoir volume into the volume of liquid, the volume of liquid being arranged for separating CO2 and the other gases by a relatively larger proportion of CO2 being dissolved in the liquid, and a relatively larger proportion of the other gases being transported in bubbles out of the liquid providing CO2 enriched liquid.

Optionally, the pressure transfer element comprises a hydraulic device which optionally comprises hydraulic liquid arranged in the first and second reservoir volumes being fluidly connected and allowing transfer of hydraulic liquid between the reservoir volumes.

Optionally, the pressure transfer element divides an enclosed volume into the first and second reservoir volumes and comprises a movable wall in the form of a piston or a membrane.

Optionally, the system comprises a turbine arranged for receiving the CO2 enriched liquid and eliciting flashing of dissolved CO2 into gas phase, generating energy, and producing degassed liquid.

Optionally, the system comprises a reservoir arranged for receiving the degassed liquid and admitting the steam under pressure into the reservoir lifting degassed liquid to a higher altitude, further optionally, the system comprises means for returning the degassed liquid into the liquid volume in a closed cycle operation.

Optionally, the means for generating steam under pressure comprises a heat exchanger arranged for receiving heat from the gas mixture.

### DESCRIPTION OF THE FIGURES

The above and further features of the invention are set forth with particularity in the appended claims and together with advantages thereof will become clearer from consideration of exemplary embodiments of the invention given with reference to the accompanying drawings.

Embodiments of the present invention will now be described, by way of example only, with reference to the following diagrams wherein:

FIGS. 1a-e show a first preferred embodiment of the present invention.

FIGS. 2a-e show a second preferred embodiment of the present invention.

### REFERENCE NUMBERS TO THE FIGURES

The following reference numbers refer to the drawings:

| Number | Designation |
|---|---|
| 1 | Flue gas |
| 2 | Tube |
| 3 | Water |
| 4 | Heat exchanger |
| 5 | Steam |
| 6 | First reservoir volume |
| 7 | Tube |
| 8 | Valve |
| 9 | Piston |
| 10a | First reservoir volume |
| 10b | Second reservoir volume |
| 11 | Second reservoir volume |
| 12 | Hydraulic liquid |
| 13 | Valve |
| 14 | Void space |
| 15 | Throttle valve |
| 16 | Valve |
| 17 | Valve |
| 18 | Dispersion device |
| 19 | Liquid |
| 20 | Column |
| 21 | Bubbles |
| 22 | Surface |
| 23 | Valve |
| 24 | Turbine |
| 25 | Volume |
| 26 | Venting tube |
| 27 | Gas |
| 28 | Liquid |
| 29 | Recipient |
| 30 | Valve |
| 31 | Reservoir |
| 32 | Reservoir |
| 33 | Valve |
| 34 | Valve |
| 35 | Void space |
| 36 | Riser tube |
| 37 | Water from riser tube |
| 38 | Returned water |
| 39 | Enclosed volume |

### DESCRIPTION OF PREFERRED EMBODIMENTS OF THE INVENTION

The present invention employs differences in the solubility of gases in a liquid to obtain separation of gases in a gas mixture. This is achieved in a high throughput process where the gas mixture is brought into contact with the liquid across a large contact area, causing the gas species with the highest solubility to dominate gas transfer into the liquid phase. The remaining gas species with lower solubility are dissolved to a smaller degree and are subsequently separated out by mechanical means.

For concreteness, it shall be assumed in the following that the gas mixture is flue gas from a combustion process and that the liquid is water. Three species are of particular interest, namely N₂, O₂ and CO₂, whose relative concentrations in the mixture may be typically 70-80%, 2.5-4% and 1-25%, respectively. Generally, it is desired to separate the CO₂ from the other gaseous species. The solubilities in water for these gases are very different, which is exploited in the present invention: Under equilibrium conditions and at 10° C. and 1 bar partial pressure, the solubilities are respectively 0,019 g. N₂ gas per kg water, 0,057 g. O₂ gas per kg water, and 2.5 g. CO₂ gas per kg water. Thus, the solubility ratio is 44:1 between CO₂ and O₂ and 132:1 between CO₂ and N₂. At saturation, i.e. when the water has been exposed to the flue gas for a long time, e.g. by bubbling, it shall have absorbed relative amounts of N₂, O₂ and CO₂ that differ from the composition of the flue gas. The CO₂ component shall typically be strongly enhanced in the water: It involves dissolved molecular CO₂ as well as carbonic acid, bicarbonate and carbonate and their reactions with cations present in the water. If one assumes that CO₂ is a simple gas, one can apply Henry's law which can be written:

$${c}_{a} = {H}^{cp} {p}_{a} \qquad Eq . 1$$

Here, H^{cp} is the Henry solubility constant, cₐ is the concentration of a species in the aqueous phase under equilibrium conditions and pₐ is the partial pressure of that species in the gas phase.

When CO2 dissolves in water, the carbon enters a chain of interacting processes:

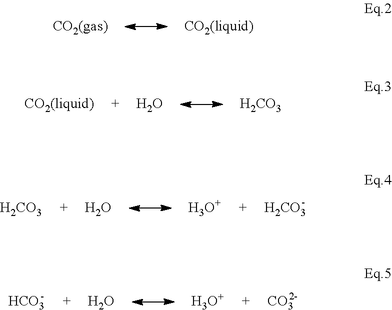

Here, CO₂ (liquid) is carbon dioxide in solvated form in the water, H₂CO₃ is carbonic acid, HCO₃⁻ is bicarbonate and CO₃²⁻ is carbonate. The relative concentrations of these species depends on the pH, with the dominant species at equilibrium and near-neutral pH being bicarbonate. The sum of these species is often referred to as dissolved inorganic carbon: DIC. The amount of DIC that can be absorbed in water depends on several factors, including the concentration and types of ionic species, as well as the temperature and CO₂ partial pressure. Thus, at 10 C and 1 bar CO₂ partial pressure, about 2.5 kg. of CO₂ can be accommodated in 1 m³ of water.

Many schemes can be devised to extract CO₂ from a mixture of gases by exploiting the solubility differentials in water. In practice, all of these involve expenditure of mechanical power in some form, in some cases to an extent where the associated energy costs become prohibitive. This is particularly notable in systems that employ electrical power to run pumps.

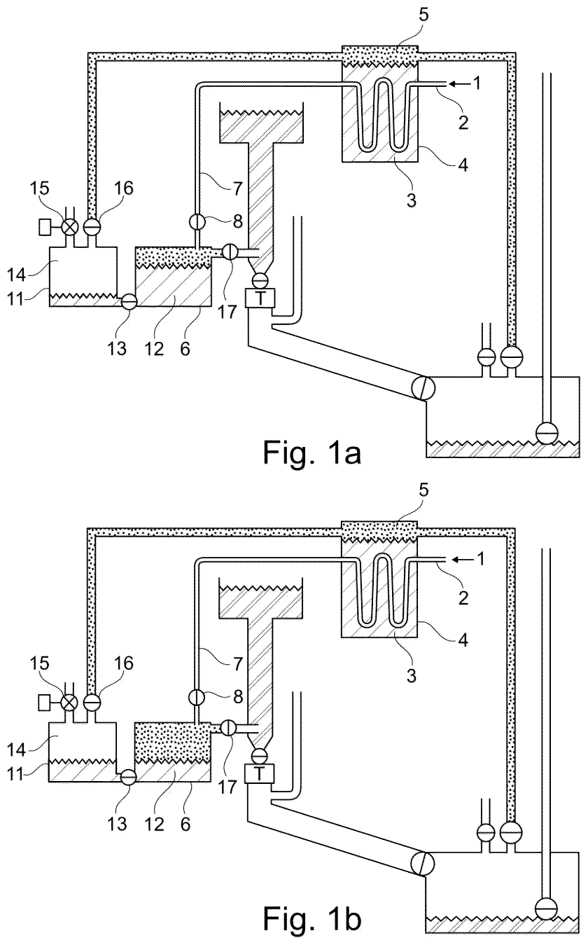

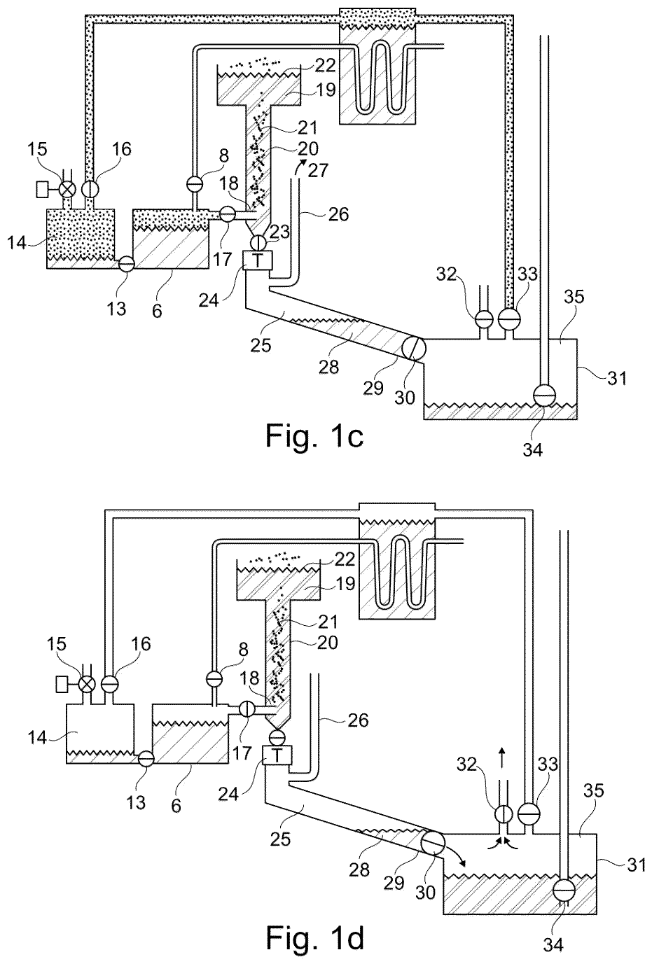

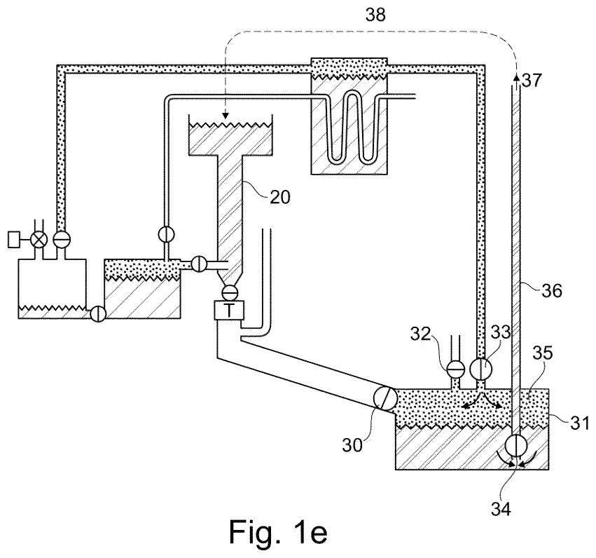

As shall be described below with reference to a first preferred embodiment of the present invention illustrated in FIGS. 1a-e, it is possible to reduce or eliminate the need for externally supplied electrical power by exploiting the thermal energy content in the hot flue gas containing the CO₂ gas that is to be removed, or from any other thermal source.

The hot flue gas (1) is introduced via a tube (2) and delivers heat to water (3) in a heat exchanger (4), producing steam (5) under pressure. The steam is employed in a sequence of steps as illustrated in FIGS. 1a-e to provide mechanical energy for operating the CO₂ separation system.

The sequence starts as shown in FIG. 1a where a first reservoir volume (6) is filled with flue gas via a tube (7) with valve (8) in open position. The flue gas is admitted via the valve (8) into the first reservoir volume (6) which is initially filled with water (12). The water is gradually displaced by the flue gas and transferred in a controlled manner to a second reservoir volume (11) via a communicating tube and valve (13). The water levels in the second reservoir volume (11) and in the first reservoir volume (6) approach a common level (cf. FIG. 1b) in a process where filling of flue gas into the first reservoir volume is coordinated with release of gas from the void space (14) in the second reservoir volume through the throttle valve (15), with the valve (16) closed. In FIG. 1c the throttle valve (15) is closed and valve (16) is open, admitting steam under pressure into the void space (14) above the water in the second reservoir volume (11). The pressure transmits into the first reservoir volume (6) via the communicating tube and valve (13). The valve (8) is now closed, and the flue gas in the first reservoir volume (6) is forced via the open valve (17) into a dispersion device (18) that injects flue gas into the water (19) in a vertical column (20). The injected gas forms bubbles (21) that float upwards in the column against downward flowing water. The constituent gases in the flue gas interact with the water: The gas transport out of the bubbles and into the water will differ between the gas species, reflecting differences in diffusivity and solubility in the water surrounding the bubble. This results in segregation of gas species where CO₂ which has the highest diffusivity and solubility is more easily transported into the water outside the bubble, while a larger proportion of the other gas species (e.g. N₂) remain inside the bubble and are transported out of the water volume when the bubble floats to the surface (22). Thus, a high degree of gas separation can be achieved by collecting the water with dissolved high solubility gas on the one hand and allowing the bubbles with the low solubility gas species to escape from the surface (22) on the other hand. Water is replenished at the top of the column and is enriched in dissolved CO₂ as it descends. Ultimately the CO₂ enriched water (19) passes through a valve (23) and a turbine (24) which generates electrical power W:

$$W = V ρ {gh}_{1} \qquad Eq . 6$$

Here V is the volumetric flow rate of water, ρ the average density of water in the column, g is the acceleration of gravity and h₁ the water column height. The water that passes through the turbine experiences a sudden pressure drop ΔP:

$$Δ P = ρ {gh}_{1} \qquad Eq . 7$$

as it exits into the volume (25) below, which communicates with the ambient atmosphere via the venting tube (26). This elicits flashing of the dissolved CO₂ into the gas phase and the flashed CO₂ gas (27) exits through the venting tube (26). The degassed water (28) flows down into a recipient (29). At a point in time, water has displaced all the flue gas in the first reservoir volume (6), the valve (17) is closed and the gas injection into the column (20) ends. The valve (23) is closed after a delay that allows most of the remaining dissolved CO₂ in the column (20) to be collected in the recipient (29).

As can be recognized at this stage, CO₂ has been separated from the other flue gas components and brought into a water phase, energy has been generated in the turbine, water with the dissolved CO₂ has been degassed and the separated CO₂ (27) has been brought out of the system in a separate venting tube (26).

Experiments and analysis have shown that this procedure can deliver a separation efficiency exceeding 97%.

The preferred embodiment shown in FIGS. 1a-e includes 2 procedures where thermal energy in the flue gas is exploited to perform mechanical work. In the first case, illustrated in FIGS. 1a-c, steam under pressure is used to inject flue gas into the water in the column (20), overcoming hydrostatic pressure and friction. In the second case, illustrated in FIGS. 1d-e, steam under pressure is used to lift degassed water from a low level to a higher level: In FIG. 1d, the valve (30) is opened and degassed water in the recipient (29) flows into a lower reservoir (31). Displaced air from the void space above the water in the reservoir escapes via the open valve (32), while the valves (33), (34) are closed. In FIG. 1e, valves (30) and (32) are closed and valves (33) and (34) are open. Steam under pressure flows into the void space (35), exerting a pressure on the water surface in the lower reservoir (31) and forcing water to enter the riser tube (36) and exit at the top (37). This opens up possibilities for closed cycle operation where water (37) emanating from the riser tube (36) is returned (38) to the top of the column (20), supplemented by a smaller amount of water added to compensate for evaporation losses. This removes the need for continuous access to large water resources.

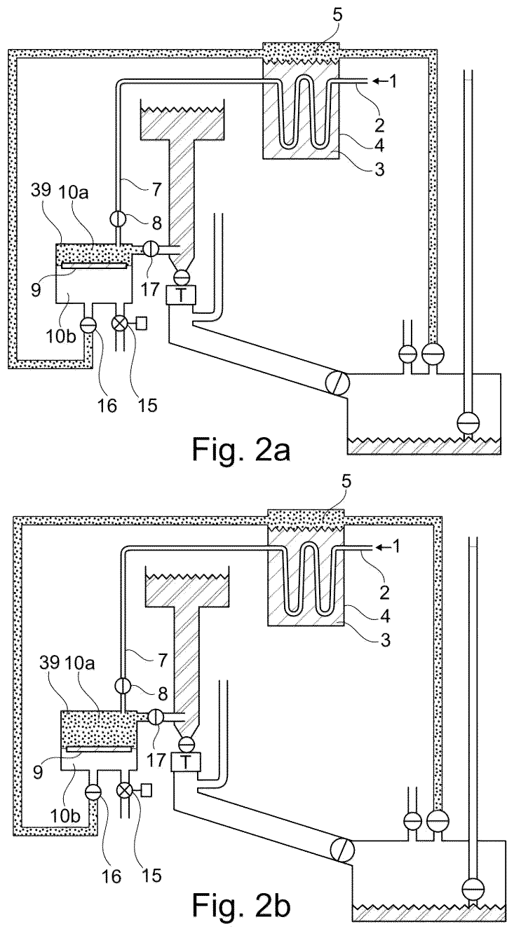

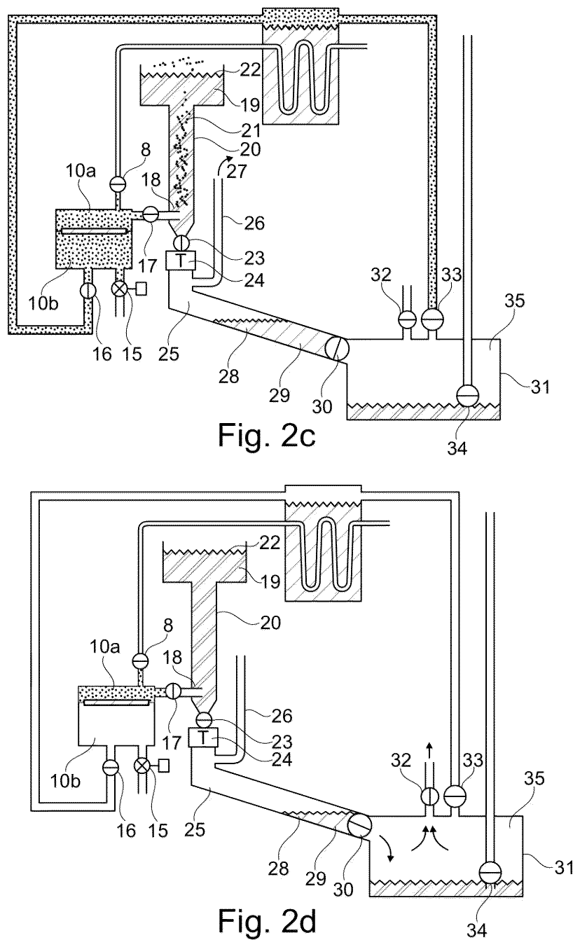

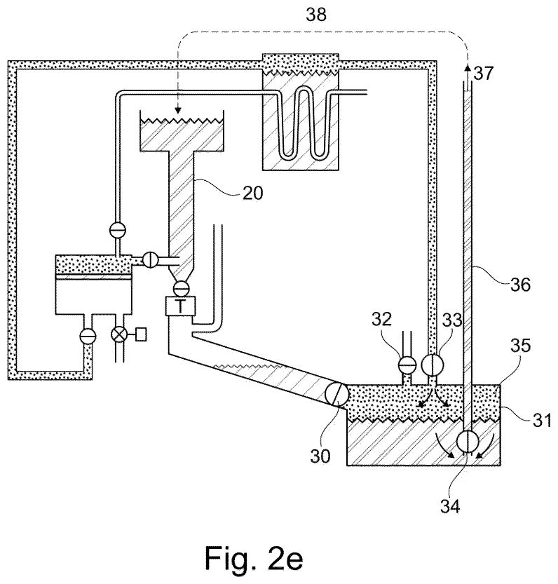

A second preferred embodiment is illustrated in FIGS. 2a-e: Instead of employing a hydraulic system (6), (11), (13) as a pressure transfer element as described in the first preferred embodiment, a movable piston (9) divides an enclosed volume (39) into a first (10a) and a second (10b) reservoir volume and transfers pressure between the two. The operational procedures are similar, however: The sequence starts as shown in FIG. 2a where the first reservoir volume (10a) above the piston receives flue gas via a tube (7), with valve (8) in open position and valve (17) in closed position. The piston is gradually displaced downwards as the flue gas fills the first reservoir volume (10a) and gas from the second reservoir volume (10b) below the piston is released to the air via throttle valve (15). The filling of flue gas into the first reservoir volume (10a) is coordinated with release of gas through the throttle valve (15), with the valve (16) closed, and proceeds until the piston is positioned at a low level as shown in FIG. 2b. In FIG. 2c the throttle valve (15) is closed and valve (16) is open, admitting steam under pressure into the second reservoir volume (10b), pushing the piston (9) upwards. The valve (8) is now closed, and the flue gas in the first reservoir volume (10a) is forced via the open valve (17) into a dispersion device (18) that injects flue gas into the water (19) in a vertical column (20). FIGS. 2d,2e show the subsequent steps in the sequence of events, which correspond directly with the steps illustrated in FIGS. 1d, 1e with reference to the first preferred embodiment.

The piston shown in FIGS. 2a-e moves as a solid entity within a closed volume, where the piston edges are sealed against the sidewalls of the closed volume. An alternative solution is to replace the piston by an elastic membrane that is permanently fixed at the edges against the sidewalls of the closed volume and which can bulge into the first and second reservoir volumes in response to pressure differences between the two.

Comparing the first and second preferred embodiments, it may be noted that the latter avoids loss of water in the form of vapour from the void space (14) during the filling of the first reservoir volume (10a) with flue gas. On the other hand, employing water as taught in the first embodiment shall in many cases allow for a simpler and more flexible system, particularly when implemented in large scale facilities.

1. A method for separating CO2 gas from a gas mixture of CO2 and other gases, the gas mixture (1) being a flue gas, using a first (6, 10A) and a second (11, 10B) closable reservoir volume separated by a pressure transfer element, and where the method comprises the following steps:
admitting the gas mixture (1) into the first reservoir volume (6, 10A), and releasing gas from the second volume (11, 10B) in a coordinated way;
suspending the admitting and the releasing;
generating steam (5) under pressure by the gas mixture (1) delivering heat to water in a heat exchanger (4), and admitting it into the second reservoir volume (11, 10B);
transmitting pressure in the second reservoir volume (11, 10B) to the first reservoir volume (6, 10A) via the pressure transfer element by a throttle valve (15) being closed and a valve (16) being open, closing a valve (8) forcing the gas mixture in the first reservoir volume (6, 10A) via an open valve (17) into a dispersion device (18) injecting the gas mixture from the first reservoir volume (6, 10A) into a volume of water (19) in a vertical column (20) with water flowing downwards, and forming bubbles (21) therein; and
dissolving in the volume of water (19) a relatively larger proportion of CO2 gas than of the other gases in the bubbles (21), transporting gas remaining in the bubbles (21) out of the volume water (19) by allowing the bubbles (21) floating to surface of the volume of water (19), thus separating CO2 gas from the gas mixture and giving CO2 enriched water.

2. The method according to claim 1, where the generating of steam (5) under pressure comprises exploiting thermal energy from a thermal source.

3. The method according to claim 2, where the thermal source comprises the gas mixture (1).

4. The method according to claim 3, where the generating of steam (5) comprises heating water in a heat exchanger (4) by the gas mixture (1).

5. The method according to claim 1, further comprising passing the CO2 enriched water through a turbine (24) eliciting flashing of dissolved CO2 into gas phase, generating energy, and producing degassed water (28).

6. The method according to claim 5, comprising collecting/removing the CO2 in gas phase.

7. The method according to claim 5, further comprising gathering the degassed water in a reservoir (31) and admitting the steam (5) under pressure into the reservoir (31) lifting the degassed water to a higher altitude.

8. The method according to claim 7, further comprising returning the degassed water (28) into the volume of water (19) in a closed cycle operation.

9. The method according to claim 7, further comprising supplementing the degassed water (28) with a smaller portion of water to compensate for evaporation losses.

10. A system for separating CO2 gas from a gas mixture (1) of CO2 and other gases, the gas mixture (1) being a flue gas, where the system comprises:
a first (6, 10A) and a second (11, 10B) reservoir volume separated by a pressure transfer element arranged to transfer pressure between the first (6, 10A) and second (11, 10B) reservoir volume;
a volume of water (19) with a surface, where the volume of water (19) is fluidly connected to the first reservoir volume (6, 10A), and where the water (19) has a higher solubility of CO2 than of the other gases;
a dispersion device (18) arranged for injecting the gas mixture (1) into the first reservoir volume (6, 10A), and a throttle valve (15) arranged for for in a coordinated way releasing gas from the second reservoir volume (11, 10B); and a heat exchanger (4) arranged for generating steam (5) under pressure by the flue gas delivering heat to water in the heat exchanger (4), and an a tube arranged for admitting the steam (5) into the second reservoir volume (11, 10B), thereby via the pressure transfer element by a throttle valve (15) being closed and a valve (16) being open, closing a valve (8) forcing the gas mixture in the first reservoir volume (6, 10A) via an open valve (17) into a dispersion device (18) injecting the gas mixture from the first reservoir volume (6, 10A) into the volume of water (19) in a vertical column (20) with water flowing downwards, the volume of water (19) being arranged for separating CO2 and the other gases by a relatively larger proportion of CO2 being dissolved in the water (19), and a relatively larger proportion of the other gases being transported in bubbles (21) out of the water providing CO2 enriched water.

11. The system according to claim 10, where the pressure transfer element comprises a hydraulic device.

12. The system according to claim 11, where the hydraulic device comprises hydraulic liquid arranged in the first (6) and second (11) reservoir volumes being fluidly connected and allowing transfer of hydraulic liquid between the reservoir volumes (6, 11).

13. The system according to claim 10, where the pressure transfer element divides an enclosed volume (39) into the first and second reservoir volumes (10A, 10B) and comprises a movable wall in the form of a piston or a membrane.

14. The system according to claim 10, further comprising a turbine (24) arranged for receiving the CO2 enriched water and eliciting flashing of dissolved CO2 into gas phase, generating energy, and producing degassed water (28).

15. The system according to claim 10, further comprising a reservoir (31) arranged for receiving the degassed water (28) and admitting the steam (5) under pressure into the reservoir (31) lifting degassed water to a higher altitude.

16. The system according to claim 15, further comprising means for returning the degassed water into the water volume in a closed cycle operation.

17. The system according to claim 10, where the means for generating steam under pressure comprises a heat exchanger (4) arranged for receiving heat from the gas mixture (1).

18.-19. (canceled)

20. The method according to claim 2, further comprising passing the CO2 enriched water through the turbine eliciting flashing of dissolved CO2 into gas phase, generating energy, and producing degassed water.

21. The method according to claim 3, further comprising passing the CO2 enriched water through the turbine eliciting flashing of dissolved CO2 into gas phase, generating energy, and producing degassed water.

22. The method according to claim 4, further comprising passing the CO2 enriched water through the turbine eliciting flashing of dissolved CO2 into gas phase, generating energy, and producing degassed water.
